(19) United States
(12) Patent Application Publication
(10) Pub. No.: US 2014/0379795 A1
(43) Pub. Date: Dec. 25, 2014

(54) SMART NOTIFICATIONS IN A SOCIAL NETWORKING SITE

(71) Applicants: Kaisuke NAKAJIMA, San Jose, CA (US); Jennifer W. Lin, San Jose, CA (US)

(72) Inventors: Kaisuke NAKAJIMA, San Jose, CA (US); Jennifer W. Lin, San Jose, CA (US)

(73) Assignee: Google Inc., Mountain View, CA (US)

(21) Appl. No.: 13/366,229

(22) Filed: Feb. 3, 2012

(51) Int. Cl. G06F 15/16

(52) U.S. Cl. 709/204

(57) ABSTRACT

A method and system are disclosed for creating and modifying calendar events in a social networking site environment. On receiving a user request to modify a data entry describing a previously scheduled event or on detecting a change to a data entry describing a previously scheduled event, a synchronous communication session is initiated among the event participants. Subsequent to initiating a synchronous communication session, the data entry describing the previously scheduled event is modified based at least in part on at least one of the user request of the synchronous communication. On receiving a user request to add a new data entry describing a new event, a synchronous communication session is initiated for all event participants. Subsequent to the initiation of the synchronous communication session, the data entry for the new event is added based on at least one of the user request of the synchronous communication.

### TECHNICAL FIELD

The subject technology relates generally to communications in a social networking site, and more particularly to smart notifications in a social networking site.

### BACKGROUND

Social networking sites have become part of every day life for a lot of users. Most users log into such sites several times a day to interact with their friends, post their latest updates, and receive the same from their friends. Users also routinely keep calendars and schedule events for themselves or groups of friends by sending calendar or event invitations to other users. Currently, if a user wishes to discuss modifying an event or to propose a change to an event, the user has to compose a message to one or more event participants, possibly unintentionally leaving out some of the event participants. Alternatively, the user may create a list of users for that event to be able to correspond with them. There is currently no convenient and efficient mechanism to communicate with event participants about changing certain details such as time, location, or duration of a certain event.

### SUMMARY

The technology presented herein provides a solution to this issue by triggering a synchronous communication session such as a live chat, a video conference, or another type of a synchronous communication, among participants of an event when one of the participants modifies event information. In one aspect, when a user wishes to schedule a new event, and submits a data entry describing the new event, every participant of the new event receives an invitation to a synchronous communication regarding the data entry describing the new event. In another aspect, when a user re-schedules or otherwise modifies a data entry describing a previously scheduled event, an invitation to a synchronous communication regarding the rescheduling or modifying of the data entry describing the previously scheduled event is sent to each event participant. Some users may opt out of receiving such synchronous communication invitations at the time they set up or personalize their social networking site or calendar profiles.

The subject technology provides a computer-implemented method for modifying a previously scheduled event at a social networking site. According to one aspect, the method includes receiving, using one or more computing devices, an indication of a request to modify a data entry describing a previously scheduled event, determining, using the one or more computing devices, two or more participants associated with the data entry describing the previously scheduled event, initiating, using the one or more computing devices, a synchronous communication session with two or more determined participants in response to the received indication of the request to modify the data entry describing the previously scheduled event, and modifying, using the one or more computing devices, the data entry describing the previously scheduled event based at least in part on at least one of the received indication of the request to modify the data entry describing the previously scheduled event or the synchronous communication session with the two or more determined participants. The operations may still further include notifying the two or more determined participants associated with the data entry of the previously scheduled event of the received indication of the request to modify the data entry describing the previously scheduled event or providing a mechanism for the synchronous communication session with the two or more determined participants, the mechanism being displayed to the two or more determined participants associated with the data entry of the previously scheduled event at the social networking site.

According to another aspect, the subject technology provides a computer-implemented method for scheduling a new event at a social networking site, and the method includes receiving, using one or more computing devices, an indication of a request to add a data entry describing a new event including two or more participants, determining, using the one or more computing devices, two or more participants associated with the data entry describing the new event, initiating, using the one or more computing devices, a synchronous communication session with the two or more determined participants in response to the received indication to add the data entry describing the new event, and adding, using the one or more computing devices, the data entry describing the new event based at least in part on at least one of the received indication of the request to add the data entry describing the new event or the synchronous communication session with the two or more determined participants.

The disclosed subject matter also relates to a system for modifying a previously scheduled event at a social networking site, the system comprising one or more processors and a non-transient machine-readable medium comprising instructions stored therein, which when executed by the processors, cause the processors to perform operations including receiving, using one or more computing devices, an indication of a request to modify a data entry describing a previously scheduled event, determining, using the one or more computing devices, two or more participants associated with the data entry describing the previously scheduled event, notifying, using the one or more computing devices, the two or more determined participants associated with the data entry describing the previously scheduled event, of the received indication of the request to modify the data entry describing the previously scheduled event, initiating a synchronous communication session with the two or more determined participants in response to the received indication of the request to modify the data entry describing the previously scheduled event, and modifying, using the one or more computing devices, the data entry describing the previously scheduled event based at least in part on at least one of the received indication of the request to modify the data entry describing the previously scheduled event or the synchronous communication session with the two or more determined participants.

The disclosed subject matter also relates to a non-transient machine-readable medium comprising instructions stored therein, which when executed by a machine, cause the machine to perform operations including receiving, using one or more computing devices, an indication of a request to add a data entry describing a new event including two or more participants, determining, using the one or more computing devices, two or more participants associated with the data entry describing the new event, initiating, using the one or more computing devices, a synchronous communication session with the two or more determined participants associated with the data entry describing the new event in response to the received indication of the request to add the data entry describing the new event, and adding, using the one or more computing devices, the data entry describing the new event based at least in part on at least one of the received indication of the request to add the data entry describing the new event or the synchronous communication session with the two or more determined participants associated with the data entry describing the new event, subsequent to the initiation of the synchronous communication session.

The operations may further include notifying the two or more determined participants associated with the data entry describing the new event, of the received indication of the request to add a data entry describing the new event. Initiating a synchronous communication session may include inviting the two or more determined participants associated with the data entry describing the new event to the synchronous communication session or receiving availability indication from two or more determined participants associated with the data entry describing the new event.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a diagram of a system for sending smart notifications in a social networking site environment according to one example of the subject technology.

FIG. 2 is a flowchart illustrating a process for modifying a previously scheduled event according to one example of the subject technology.

FIG. 3 is a flowchart illustrating a process for scheduling a new event according to one example of the subject technology.

FIG. 4 is a diagram illustrating a machine or computer for sending smart notifications in a social networking site, including a processor and other internal components, according to one example of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

### I. Overview

The disclosed technology relates to novel methods and systems for modifying a previously scheduled event or scheduling a new event at a social networking site. According to an aspect of the disclosed technology, an event may be a calendar event, a task, or another similar event available through a calendaring or another planning application at a social networking site. Although the subject technology is discussed in the context of a social networking site, any other application capable of carrying out the methods disclosed herein is within the scope of the subject disclosure.

According to an aspect of the subject disclosure, a participant of a previously scheduled event wishing to modify the event may request that a data entry describing the previously scheduled event be modified. Such request or indication thereof, may be received at a social networking site when the participant modifies a data entry describing the previously scheduled event. The data entry may be a part of event information such as date, time, duration, location or another event parameter. An indication of such request may also be received when an event participant submits such request to modify a data entry describing a previously scheduled event through an “Options,” “Tools” or another similar application menu. Upon receipt at the system of the indication of the request to modify a data entry describing a previously scheduled event or, alternatively, a request to add a data entry describing a new event, two or more participants associated with the data entry may be determined. A synchronous communication session may be initiated between two or more determined participants of the new event or previously scheduled event. A synchronous communication session may include a live chat, a video conference, or another similar communication. A window, dialog box or an external application may pop up or be called upon at the social networking site to start the synchronous communication session between the participants. The synchronous communication session may be carried out at the social networking site or at a device corresponding to each of the two or more participants who is available to participate in the synchronous communication session. Availability of the two or more determined participants may be obtained from their status at the social networking site or from their response to an invitation that may be sent to the two or more determined participants inviting them to the synchronous communication session. The two or more determined participants may accept, decline or snooze the initiated synchronous communication session. When no response is received from the two or more determined participants of the previously scheduled event or the new event, the synchronous communication session may be cancelled.

After the synchronous communication session is initiated by the system, a data entry describing a previously scheduled event may be modified or, a data entry describing a new event may be added, as appropriate. For example, upon receiving a request or an indication thereof from an event participant to change a data entry describing the previously scheduled event, such as the time or location, for example, two or more event participants are determined and a synchronous communication session may be initiated during which the two or more participants may discuss the new time or location of the previously scheduled event. The two or more participants may choose a new time or location, and that new chosen time or location may be the new time or location for the event. If no event participants were available for the synchronous communication session, the new time or location proposed by the participant who initiated the modification to the time or location may be the new time or location for the event.

As such, an event may be scheduled or modified based on at least one of the received indication of a request to add or modify a data entry describing a new or previously scheduled event or the synchronous communication session. According to an aspect of the subject disclosure, a data entry describing a new or previously scheduled event may be so added or modified when a synchronous communication session between event participants does not happen at all or when the result of the session is to follow the received indication of request to add or modify the data entry describing the new or previously scheduled event. Alternatively, an event may be scheduled or modified according to the synchronous communication session when a different time or location is agreed upon by the participants during the session, or a combination thereof. According to an aspect of the subject disclosure a new data entry may be added or a previously scheduled event may be modified directly through the synchronous communication session environment. A mechanism may be provided during the synchronous communication session that causes a data entry to be so added or modified.

The phrase “synchronous communication” or “synchronous communication session” as interchangeably used herein is given its plain and ordinary meaning including, but not limited to, any kind of communication over the Internet, including point-to-point communications as well as multicast communications from one sender to many receivers, that offers an immediate (e.g., initiated immediately and send in due course) transmission of text-based, video, or audio messages from sender to receiver. The term further encompasses any kind of communication that offers a transmission of text-based, audio or video (or other multi-media content) messages from a sender to a receiver and may include point-to-point communications as well as multicast communications from one sender to many receivers. The direct text-based communication and other transmission of text-based messages may be instantaneous, immediate, or may be queued for transmission based on system and network resources. More advanced synchronous communication software clients may also allow enhanced modes of communication, such as live voice or video calling and inclusion of links to media. The user's messages may be conveyed over a network, such as the Internet.

The phrase “social networking site” as used herein encompasses its plain and ordinary meaning, including, but not limited to, an online service, platform or site that focuses on building and reflecting of social associations among users. These associations may be stored within a social graph at the social networking service. Such user associations may be defined on a user-to-user basis, or as a group of users associated through membership within a group. As used herein, “participants” refer to other users at one or more social networking sites. As one example, a participant may have a user account at the social networking site.

### II. Example Client-Server Network Environment for Sending Smart Notifications

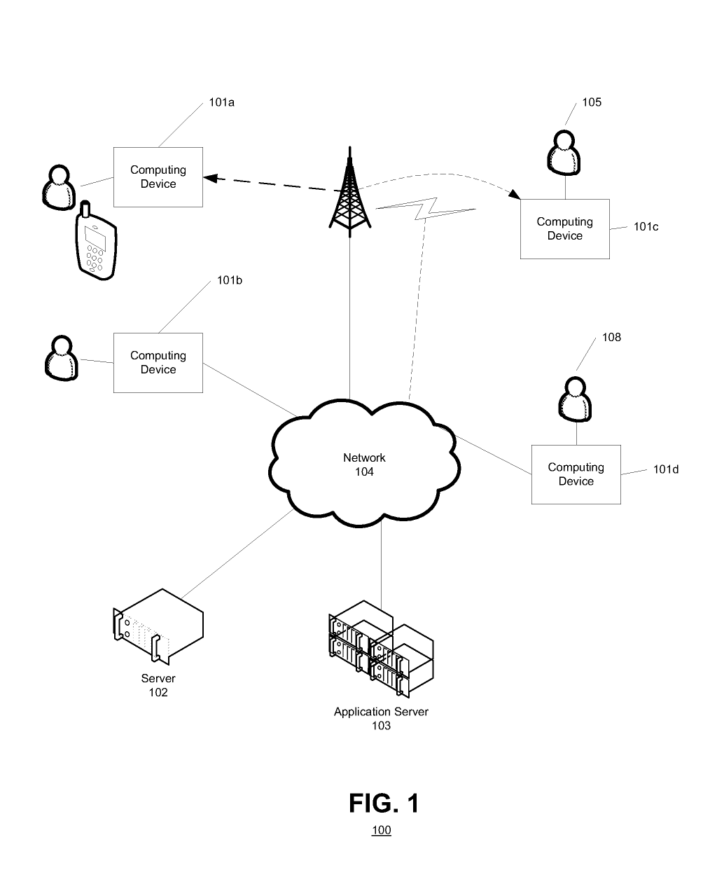

FIG. 1 is a diagram of a system 100 for sending smart notifications in a social networking site environment according to one aspect of the subject technology. In some example embodiments, smart computing devices 101(a), 101(b), 101(c) or 101(d) can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. System 100 may include one or more smart computing devices 101(a), 101(b), 101(c), or 101(d) and one or more servers 102. Servers 102 may be responsible for hosting a social networking site, including calendar functions, message boards, synchronous communications, forum discussions and the like. Servers 102 may also be responsible for sending and receiving electronic messages such as synchronous communications, to computing devices 101(a), 101(b), 101(c), or 101(d) over a network 104 (for example, a LAN, WAN, WiFi, or the Internet) or causing such messages to be sent. Servers 102 also may be configured to provide one or more application programming interfaces (APIs) for the integration of mobile-to-web extension applications.

For example, a social networking site hosted by servers 102 may include a calendar application that allows users of the social networking site to schedule events for themselves or a group of friends. Users may schedule an event directly through the social networking site application or import event information from another application. In one aspect, user 105 may schedule a new calendar event at a social networking site hosted by servers 102. On receiving a new calendar event, servers 102 may send notifications to event participants, informing them of the request to schedule a new event and inviting them to a synchronous communication. Event participants may, for example, be users 106, 107, and 108. Servers 102 may then initiate a synchronous communication session among all of the available event participants to discuss the new calendar event.

In another aspect, user 106 may modify a previously scheduled calendar event. On receiving an indication of a request to modify the previously scheduled event, the servers 102 may send notifications to the participants of that event, for example, users 105, 107, and 108, informing them of the request to modify the previously scheduled event and invite them to a synchronous communication. Servers 102 may then initiate a synchronous communication session among all of the available users to discuss the modification to the previously scheduled event. Servers 102 may then modify the previously scheduled event.

In another aspect, servers 102 may be equipped to detect that a modification to event information for a previously scheduled event X has occurred. The servers 102 may send notifications to all of the event attendees and initiate a synchronous communication session among the event attendees to discuss the detected modification.

Applications servers 103 or another mechanism connected to network 104 may be equipped to handle sending or causing notifications to be sent to users, initiating synchronous communication sessions or supporting the calendar or other user applications. To this end, servers 102 may merely make a determination that a user is utilizing a calendar application and then send that information to applications servers 103 to continue with the calendaring functions or other functions disclosed herein.

### III. Example Processes for Alerting a Previously Scheduled Event or Scheduling a New Event

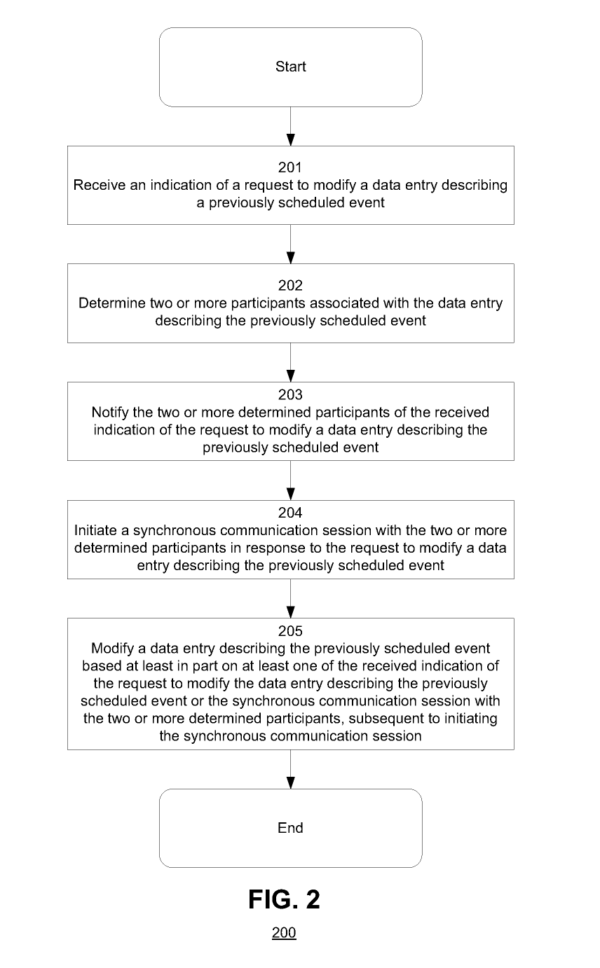

FIG. 2 is a flowchart illustrating a process for modifying a previously scheduled event according to one aspect of the subject technology. According to one aspect, a social networking site of an exemplary system 100 may be integrated with a calendaring service hosted by servers 102, applications servers 103 or another similar mechanism. In a first block 201, an indication of a user request to modify a data entry describing a previously scheduled event is received at a server. In one aspect, receiving an indication of a user request to modify a data entry describing a previously scheduled event may include receiving an indication of a change having been made to event information, such as, for example, a change in the date, time or location of the event. In another aspect, receiving an indication of a user request to modify a previously scheduled event may include receiving an indication of another action, such, for example, an indication of the user engaging a “Modify Event Information” or another similar option or tool from a calendar menu. Other similar actions may be treated as an indication of a user request to modify a data entry describing a previously scheduled event. On receiving the indication of the request, in a second block 202, two or more participants associated with the data entry describing the previously scheduled event are determined. The participants may be determined from the list of event attendees associated with the event. The participants may already be confirmed attendees or, alternatively, invitees who have not committed to the event. Invitees who declined the event may also be included in the list of participants determined at block 202. To that end, two or more event participants may be identified, flagged, selected or otherwise noted at the system for future communications regarding the event. One of the two or more determined participants may be the participant who initiates the request to modify a data entry describing the previously scheduled event. Thus, according to an aspect of the subject disclosure, the two or more determined participants may include the participant who is making the request and one or more other participants of the previously scheduled event.

At block 203, the two or more determined event participants may be notified of the received indication of the request to modify a data entry describing the previously scheduled event. The participants may be notified via a message at the social networking site, a dialog box, email, or other suitable communication means.

In response to the received indication of the request to modify a data entry describing the previously scheduled event, servers 102, applications servers 103 or another similar mechanism initiates a synchronous communication session with the two or more determined participants at block 204. To that end, a mechanism for the synchronous communication session with the two or more determined participants may be displayed to the two or more determined participants at the social networking site. A dialog box may be opened at a device corresponding to each of the two or more determined participants. In one aspect, as part of process 204 or in addition thereto, an invitation may be sent to the two or more determined participants by servers 102, applications servers 103 or another similar mechanism, inviting the two or more participants to discuss modifying a data entry describing the previously scheduled event in a synchronous communication session. The invitation may be in a form of a message at the social networking site, a dialog box, an email or another suitable form of communication. The availability of the two or more participants may also be determined from the two or more participants' status at the social networking site.

The two or more determined participants may respond to indicate their availability, suggest postponing the proposed synchronous communication session by a predetermined number of minutes or hours, or ignore the invitation. The available two or more determined participants may then be connected to the synchronous communication session immediately or, if a wait was requested, after the predetermined wait. Thus, the initiated synchronous communication session may take place when the two or more determined participants are available, or it may be postponed when the two or more determined participants requests a wait. The initiated synchronous communication session may, alternatively, be cancelled by the system when none of the two or more determined participants is available, when an invitation or a dialog box is ignored for some pre-determined time, or when so requested by the two or more determined participants.

The synchronous communication session may include a graphic user interface through which the event may be modified or it may include a summary of the event parameters to facilitate the discussion of the event among the two or more determined participants. According to and aspect of the subject disclosure, the event may be modified directly through the synchronous communication session by one or more of the two or more determined participants. That is, the event may be modified directly at or from the synchronous communication session.

Subsequent to initiating the synchronous communication session with the two or more determined participants, the previously scheduled event is modified based at least in part on at least one of the received indication of the request to modify the data entry describing the previously scheduled event or the synchronous communication session with the two or more determined participants at block 205 by the servers 102, applications servers 103 or another similar mechanism. An indication of a new data entry describing the previously scheduled event may be received from at least one of the received indication of the request to modify the data entry describing the previously scheduled event or the synchronous communication session with the two or more determined participants, and the data entry describing the previously scheduled event may be modified according to the new data entry received from at least one of the received indication of the request to modify the data entry describing the previously scheduled event or the synchronous communication session with the two or more determined participants.

In one aspect, a data entry describing the previously scheduled event may be modified according to the new data entry describing the previously scheduled event after the conclusion of the synchronous communication session among the available two or more determined participants. In another aspect, a data entry describing the previously scheduled event may be so modified when none of the two or more determined participants accepts the invitation to the synchronous communication session or if the invitation is simply ignored by the two or more determined participants. A time mechanism may be implemented for allowing a time frame within which the two or more determined participants may accept, postpone, or decline the invitation to the synchronous communication session. If no response is received at the servers 102, applications servers 103 or another similar mechanism, the invitation may be deemed ignored.

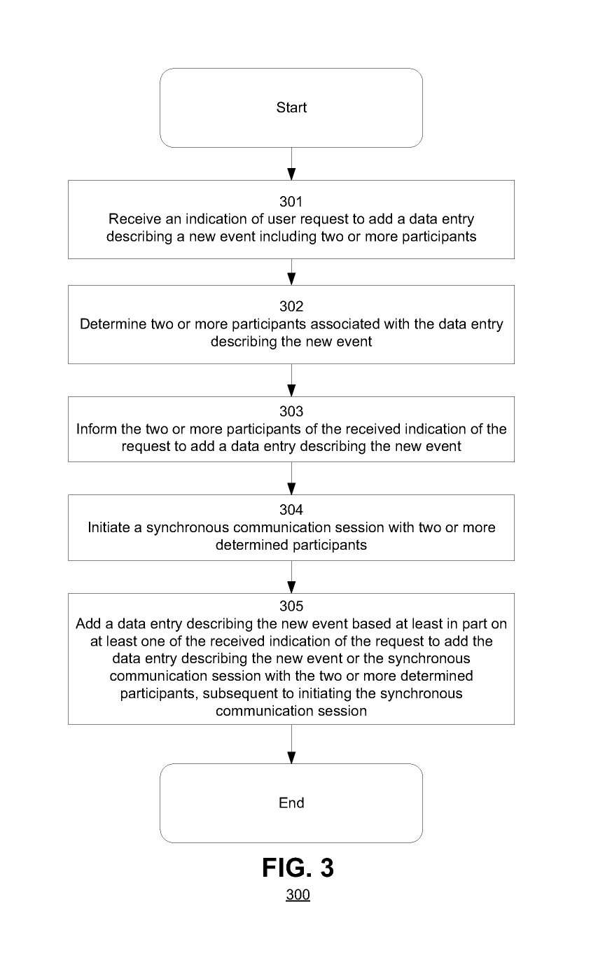

FIG. 3 is a flowchart illustrating a process for scheduling a new event according to an aspect of the subject disclosure. In a first block 301, an indication of a request to add a data entry describing a new event that includes two or more participants is received at a server such as servers 102, applications servers 103 or another similar mechanism. On receiving the indication of the request, in a second block 302, two or more participants associated with the data entry describing the new event are determined. The participants may be determined from a list of event participants associated with the event. The list of participants may be compiled by a user when making the request to add a data entry describing a new event. Participants may also be determined from a list of attendees from another event or imported from another application or tool. To that end, the two or more event participants may be identified, flagged, selected or otherwise noted at the system for future communications regarding the new event. One of the two or more determined participants may be the participant who initiates the request to add a data entry describing the new event. Thus, according to an aspect of the subject disclosure, the two or more determined participants may include the participant who is making the request and one or more other participants of the new event. At block 303, the two or more determined participants associated with the data entry describing the new event may be notified of the request to add a data entry describing a new event or schedule a new event. The two or more participants may be notified via a message at the social networking site, a dialog box, email, or other suitable communication means.

In response to the received indication of the request to add a data entry describing the new event, servers 102, applications servers 103 or another similar mechanism initiates a synchronous communication session with the two or more determined participants at block 304. To that end, a mechanism for the synchronous communication session with the two or more determined participants may be displayed to the two or more determined participants at the social networking site. A dialog box may open at a device corresponding to each of the two or more determined participants. In one aspect, as part of block 304 or in addition thereto, an invitation may be sent to the two or more determined participants by servers 102, applications servers 103 or another similar mechanism, inviting them to discuss scheduling the new event or adding the data entry describing the new event in the synchronous communication session. The invitation may be a message at the social networking site, a dialog box, an email or another suitable form of communication. As previously discussed with reference to FIG. 2, the two or more determined participants may then respond to indicate their availability, suggest postponing the proposed synchronous communication session by a predetermined number of minutes or hours, or ignore the invitation. Availability indication may also be obtained from the participants' availability status at the social networking site. The participants' status may indicate whether the two or more determined participants are available for a synchronous communication session. The available two or more determined participants are connected to the synchronous communication session immediately or, if a predetermined wait time was requested, after the predetermined wait. The initiated synchronous communication session may, alternatively, be cancelled by the system when none of the two or more determined participants is available, when an invitation or a dialog box is ignored for some pre-determined time, or when requested by one of the two or more determined participants.

The synchronous communication session may include, call on, or reference a tool or a graphic user interface through which an event may be created and a data entry describing the new event may be added. Alternatively, a synchronous communication session may include, call on, or reference a tool with selectable or fill-able event parameters that may be discussed among the two or more determined participants. According to and aspect of the subject disclosure, the new event may be created through the synchronous communication session by one or more of the two or more determined participants. The new event may be created at or from the synchronous communication session.

Subsequent to initiating the synchronous communication session, the new event is scheduled at block 305. To that end, a data entry describing the new event is added, based at least in part on at least one of the received indicating of the request to add the data entry describing the new event or the synchronous communication session with the two or more determined participants. In one aspect, the new event may be scheduled after the conclusion of the synchronous communication session among the available two or more determined participants. In another aspect, the new event may be scheduled when none of the two or more determined participants accepts the invitation to the synchronous communication session or if the invitation is simply ignored by the two or more determined participants. Similarly to the discussion with reference to FIG. 2, a time mechanism may be implemented for allowing a time frame within which the two or more determined participants may accept, postpone, or decline the invitation to the synchronous communication session. If no response is received, the invitation may be deemed ignored.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

### IV. Example System for Scheduling a New Event or Modifying a Previously Scheduled Event

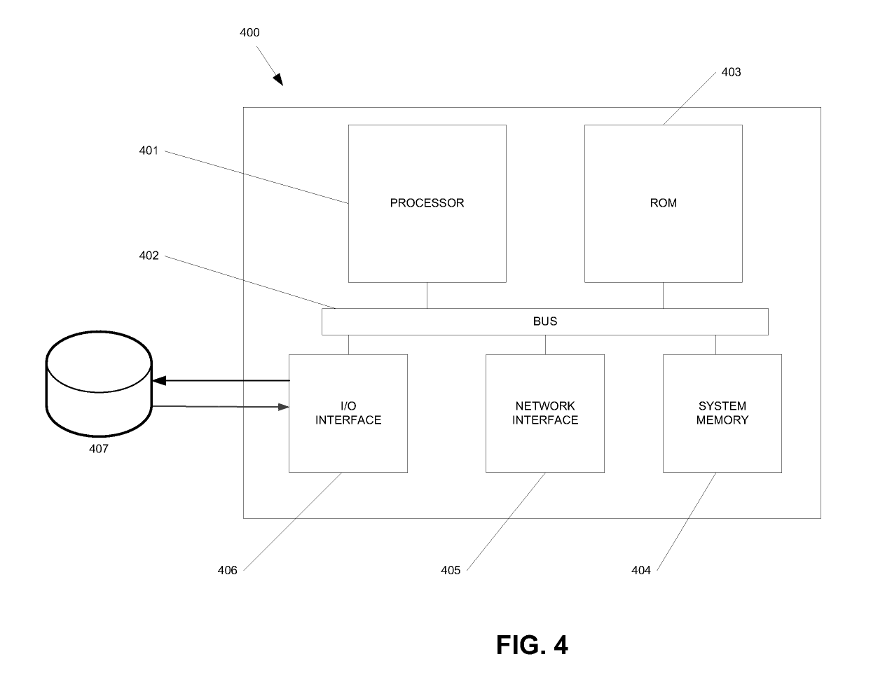

FIG. 4 is a diagram illustrating a machine or computer for scheduling a new event or modifying a previously scheduled event, including a processor and other internal components, according to one aspect of the subject technology. Electronic system 400 can be a server, computer, phone, PDA, laptop, tablet computer, television with one or more processors embedded therein or coupled thereto, or any other sort of electronic device. In some aspects, a computerized device 400 (for example, computing device 101, server 102 or 103, or the like) includes several internal components such as a processor 401, a system bus 402, read-only memory 403, system memory 404, network interface 405, I/O interface 406, and the like. In one aspect, processor 401 may also be in communication with a storage medium 407 (for example, a hard drive, database, or data cloud) via I/O interface 406. In some aspects, all of these elements of device 400 may be integrated into a single device. In other aspects, these elements may be configured as separate components.

Processor 401 may be configured to execute code or instructions to perform the operations and functionality described herein, manage request flow and address mappings, and to perform calculations and generate commands. Processor 401 is configured to monitor and control the operation of the components in server 400. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 401. Likewise, one or more sequences of instructions may be software stored and read from system memory 404, ROM 403, or received from a storage medium 407 (for example, via I/O interface 406). ROM 403, system memory 404, and storage medium 407 represent examples of machine or computer readable media on which instructions/code may be executable by processor 401. Machine or computer readable media may generally refer to any medium or media used to provide instructions to processor 401, including both volatile media, such as dynamic memory used for system memory 404 or for buffers within processor 401, and non-volatile media, such as electronic media, optical media, and magnetic media.

In some aspects, processor 401 is configured to communicate with one or more external devices (for example, via I/O interface 406). Processor 401 is further configured to read data stored in system memory 404 and/or storage medium 407 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like.

In some aspects, system memory 404 represents volatile memory used to temporarily store data and information used to manage device 400. According to one aspect of the subject technology, system memory 404 is random access memory (RAM) such as double data rate (DDR) RAM. Other types of RAM also may be used to implement system memory 404. Memory 404 may be implemented using a single RAM module or multiple RAM modules. While system memory 404 is depicted as being part of device 400, those skilled in the art will recognize that system memory 404 may be separate from device 400 without departing from the scope of the subject technology. Alternatively, system memory 404 may be a non-volatile memory such as a magnetic disk, flash memory, peripheral SSD, and the like.

I/O interface 406 may be configured to be coupled to one or more external devices, to receive data from the one or more external devices and to send data to the one or more external devices. I/O interface 406 may include both electrical and physical connections for operably coupling I/O interface 406 to processor 401, for example, via the bus 402. I/O interface 406 is configured to communicate data, addresses, and control signals between the internal components attached to bus 402 (for example, processor 401) and one or more external devices (for example, a hard drive). I/O interface 406 may be configured to implement a standard interface, such as Serial-Attached SCSI (SAS), Fiber Channel interface, PCI Express (PCIe), SATA, USB, and the like. I/O interface 406 may be configured to implement only one interface. Alternatively, I/O interface 406 may be configured to implement multiple interfaces, which are individually selectable using a configuration parameter selected by a user or programmed at the time of assembly. I/O interface 406 may include one or more buffers for buffering transmissions between one or more external devices and bus 402 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for modifying a previously scheduled event at a social networking site, the method comprising:
receiving, using one or more computing devices, an indication of a request to modify a data entry describing a previously scheduled event;
determining, using the one or more computing devices, two or more participants associated with the data entry describing the previously scheduled event;
initiating, using the one or more computing devices, a synchronous communication session with the two or more determined participants in response to the received indication of the request to modify the data entry describing the previously scheduled event, the synchronous communication session being different than the previously scheduled event; and
modifying, using the one or more computing devices, the data entry describing the previously scheduled event, wherein the modifying is done directly through a synchronous communication session tool by one or more of the determined participants

2. The computer-implemented method of claim 1, wherein the modifying comprises:
receiving, using the one or more computing devices, an indication of a new data entry describing the previously scheduled event from at least one of the received indication of the request to modify the data entry describing the previously scheduled event or the synchronous communication session with the two or more determined participants; and
modifying, using the one or more computing devices, the data entry describing the previously scheduled event according to the new data entry received from at least one of the received indication of the request to modify the data entry describing the previously scheduled event or the synchronous communication session with the two or more determined participants.

3. The computer-implemented method of claim 1, wherein initiating the synchronous communication session with the two or more determined participants associated with the data entry describing the previously scheduled event further comprises:
providing a mechanism for the synchronous communication session with the two or more determined participants associated with the data entry describing the previously scheduled event, the mechanism being displayed to the two or more determined participants at the social networking site.

4. (canceled)

5. The computer-implemented method of claim 1, wherein one of the two or more determined participants is a participant from whom the indication of the request to modify the data entry describing the previously scheduled event is received.

6. The computer-implemented method of claim 1, further comprising:
notifying, using the one or more computing devices, at least one of the two or more determined participants of the previously scheduled event, of the received indication of the request to modify the data entry describing the previously scheduled event.

7. The computer-implemented method of claim 1, wherein the modifying is performed subsequent to initiating the synchronous communication session.

8. The computer-implemented method of claim 1, wherein initiating the synchronous communication session includes inviting the two or more determined participants associated with the data entry describing the previously scheduled event to the synchronous communication session.

9. The computer-implemented method of claim 1, wherein initiating the synchronous communication session includes obtaining an availability indication from the two or more determined participants associated with the data entry describing the previously scheduled event.

10. The computer-implemented method of claim 8, wherein the availability of the two or more determined participants associated with the data entry describing the previously scheduled event is obtained from the status of the two or more determined participants associated with the data entry describing the previously scheduled event, at the social networking site.

11. The computer-implemented method of claim 1, wherein initiating the synchronous communication session with the two or more determined participants associated with the data entry describing the previously scheduled event includes opening a dialog box at a device corresponding to each of the two or more determined participants.

12. A computer-implemented method executed for scheduling a new event at a social networking site, the method comprising:
receiving, using one or more computing devices, an indication of a request to add a data entry describing a new event including two or more participants;
determining, using the one or more computing devices, two or more participants associated with the data entry describing the new event;
initiating, using the one or more computing devices, a synchronous communication session with the two or more determined participants in response to the received indication of the request to add the data entry describing the new event, the synchronous communication session being different than the previously scheduled event;
postponing the synchronous communication session when a wait is requested by the two or more determined participants; and
adding, using the one or more computing devices, the data entry describing the new event, wherein the adding is done directly through a synchronous communication session tool by one or more of the determined participants.

13. The computer-implemented method of claim 12, wherein the adding comprises:
receiving, using the one or more computing devices, an indication of a new data entry describing the new event from at least one of the received indication of the request to add the data entry describing the new event or the synchronous communication session with the two or more determined participants; and
adding, using the one or more computing devices, the new data entry describing the new event according to the data entry describing the new event received from at least one of the received indication of the request to add the data entry describing the new event or the synchronous communication session with the two or more determined participants.

14. The computer-implemented method of claim 12, wherein the adding, comprises:
providing a mechanism for the synchronous communication session with the two or more determined participants associated with the data entry describing the new event, the mechanism being displayed to the two or more participants at the social networking site.

15. (canceled)

16. The computer-implemented method of claim 15, wherein the adding is performed subsequent to initiating the synchronous communication session.

17. The computer-implemented method of claim 12, further comprising, notifying the two or more participants associated with the data entry describing the new event of the received indication of the request to add the data entry describing the new event.

18. The computer-implemented method of claim 12, wherein initiating a synchronous communication session with the two or more participants associated with the data entry describing the new event includes inviting the two or more participants to the synchronous communication session.

19. The computer-implemented method of claim 12, wherein initiating a synchronous communication session with the two or more participants associated with the data entry describing the new event includes receiving availability indication from the two or more participants.

20. The computer-implemented method of claim 19, wherein the availability of the two or more participants associated with the data entry describing the new event is obtained from the status of the two or more participants at the social networking site.

21. The computer-implemented method of claim 12, wherein initiating the synchronous communication session with the one or more participants includes opening a dialog box at a device corresponding to each of the one or more participants.

22. A system for modifying a previously scheduled event at a social networking site, the system comprising:
one or more processors; and
a non-transient machine-readable medium comprising instructions stored therein, which when executed by the processors, cause the processors to perform operations comprising:
receiving, using one or more computing devices, an indication of a request to modify a data entry describing a previously scheduled event;
determining, using the one or more computing devices, two or more participants associated with the data entry describing the previously scheduled event;
notifying, using the one or more computing devices, the two or more determined participants associated with the data entry describing the previously scheduled event, of the received indication of the request to modify the data entry describing the previously scheduled event;
initiating a synchronous communication session with the two or more participants in response to the received indication of the request to modify the data entry describing the previously scheduled event, the synchronous communication session being different than the previously scheduled event; and
modifying, using the one or more computing devices, the data entry describing the previously scheduled event, wherein the modifying is done directly through a synchronous communication session tool by one or more of the determined participants.

23. The system of claim 22, the operations further comprising:
inviting the two or more participants associated with the data entry describing the previously scheduled event to the synchronous communication session.

24. The system of claim 22, the operations further comprising:
obtaining an availability indication from the two or more participants associated with the data entry describing the previously scheduled event.

25. A non-transient machine-readable medium comprising instructions stored therein, which when executed by a machine, cause the machine to perform operations comprising:
receiving, using one or more computing devices, an indication of a request to add a data entry describing a new event including two or more participants;
determining, using the one or more computing devices, two or more participants associated with the data entry describing the new event;
initiating, using the one or more computing devices, a synchronous communication session with the two or more determined participants associated with the data entry describing the new event in response to the received indication of the request to add the data entry describing the new event, the synchronous communication session being different than the previously scheduled event;
cancelling the initiated synchronous communication session when an invitation is ignored for a pre-determined length of time or when requested by the two or more determined users; and
adding, using the one or more computing devices, the data entry describing the new event, wherein the adding is done directly through a synchronous communication session tool by one or more of the determined participants.

26. The non-transient machine-readable medium of claim 25, further comprising:
notifying, the two or more determined participants associated with the data entry describing the new event, of the received indication of the request to add a data entry describing the new event.

27. The non-transient machine-readable medium of claim 25, wherein initiating a synchronous communication session with the two or more determined participants associated with the data entry describing the new event includes inviting the two or more determined participants to the synchronous communication session.

28. The non-transient machine-readable medium of claim 25, wherein initiating a synchronous communication session with the two or more determined participants associated with the data entry describing the new event includes receiving availability indication from the two or more determined participants.

29. The non-transient machine-readable medium of claim 25, further comprising:
providing a mechanism for the synchronous communication session with the two or more determined participants associated with the data entry describing the new event, the mechanism being displayed to the two or more participants at the social networking site.
